(19) United States
(12) Patent Application Publication
(10) Pub. No.: US 2009/0210332 A1
(43) Pub. Date: Aug. 20, 2009

(54) Method and Device for Switching Tariffs in an Electronic Communications Network

(75) Inventor: Stefan Karlsson, Karlskrona (SE)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET LM ERICSSON, Stockholm (SE)

(21) Appl. No.: 11/887,944

(22) PCT Filed: Sep. 30, 2005
(86) PCT No.: PCT/SE2005/001455

§ 371 Date: Dec. 31, 2008

(30) Foreign Application Priority Data
Apr. 8, 2005 (SE) 0500836-2

(51) Int. Cl. G06Q 30/00; H04M 11/00; G06Q 50/00

(52) U.S. Cl. 705/34; 455/406

(57) ABSTRACT

The present invention relates generally to a method and device for switching tariffs for charging of services in an electronic communications network, and more particularly to a method and device for switching tariffs for combining charging of a service which usage is not continually consumed at a regular rate in an electronic communications network.

### FIELD OF THE INVENTION

The present invention relates generally to a method and device for switching tariffs for charging of services in an electronic communications network, and more particularly to a method and device for switching tariffs for combining charging of a service which usage is not continually consumed at a regular rate in an electronic communications network.

### DESCRIPTION OF THE PRIOR ART

Real time charging systems is used by both prepaid and postpaid rating to provide user spending control and service provider control in communications networks.

Prior art charging systems provide time based rating and volume based rating separately to obtain time or volume charging. Time charging supports time-in-session switches and absolute time switches of tariffs for service usage in the communications system. Volume charging supports volume (i.e accumulated volume in session and PDP (Packet Data Protocol) Context) and absolute time switches. The absolute time is managed by translation of the volume into time.

Generally the rating logic has a rating tree that ends up in a number of leaves that defines fees, rates and charging intervals. The fee is a cost applied to an event once. However, the rate tells the cost per unit type, e.g time, volume, or events such as number of SMSs, number of downloads, and the charging interval defines the smallest unit type, e.g a volume measurement such as bytes, or event types, e.g pieces, or parts, to charge, i.e reserve/deduct. According to a charging method, each started interval is to be charged. For example, if a call is 2 minutes and 6 seconds and the active tariff uses the rate of 1 SEK per minute with a charging interval of 30 seconds, the user will be charged ROUND_UP((2*60+6)/30)*1*(30/60)=2.5 SEK.

The reservation at the account before the deduction is based on a parameter that states a requested reservation time, i.e the preferred reservation time. The requested reservation time could be requested from the client system or be set within the system e.g. on subscriber class, service class, service (or unite type). The charging control rates and applies the above charging method, but since monetary units corresponding to full charging intervals are reserved, the time reserved could be larger than the requested time. This is solved by applying the reservation amount for time covering full charging intervals but sending the granted time equal to the requested amount to the requester. This means that monetary units reserved on the account generally corresponds to more time than granted/sent to the requester.

Depending on different conditions the applied tariff/tariffs may be switched. Delayed tariff switch and immediate tariff switch are two well known conventional tariff switching methods having their origin in pulse meter solutions. Tariffs consist of a rate and the minimum charging interval that shall be charged. Usually full intervals are always charged (“telephone kiosk method”) but sometimes only completed intervals are charged.

The delayed switching always completes the active tariff before the next is started, even if there is a switch condition during the current interval. This switch is taken care of when the active interval is completed.

The immediate switch on the other hand does an immediate switch even during and within an ongoing interval. However, the %-age of the tariff executed in the last interval is stored before the switching takes places. The stored %-age of the executed tariff is then applied on the interval of the new tariff and the corresponding part is deducted from the new interval. According to one example an old interval is 30 seconds and the new interval is 60 second. The call executes 12 seconds of the old interval, which corresponds to 40% of the old interval when the switch occurs. 40% of the new interval corresponds to 24 seconds. This means that the processing in the new interval starts with the time meter set on 60−24=36 seconds. This method could be seen as keeping the relative level in the interval when charging.

In case of time based charging and a tariff switch at an absolute time that takes place during a deduction period, it is possible to predict and to know exactly when the switch will take place and when the new tariff should be applied. This is illustrated by the following example using the telephone kiosk method with a requested reservation time of 240 seconds initiated by a requester. A first tariff of 1 sek/minute and a charging interval of 60 seconds, and a second tariff of 2 sek/minute and a charging interval of 30 seconds are used. A tariff switch is set to an absolute time 18:00 and the call starts at 17:58:30. The rating will select 2 charging intervals of the first tariff ending at 17:59:30 and 18:00:30, respectively, and 4 charging intervals of the second tariff ending at 18:01:00, 18:01:30, 18:02:00, and 18:02:30, respectively. These 2+4 intervals makes up the 240 seconds requested reservation time to a cost of 1+1+1+1+1+1=6 sek. The response to the requester will be to report back after 240 seconds. 6 SEK is reserved on the account.

For traditional time based services such as speech, the quota is continuously consumed at the regular rate of 60 seconds per minute. The charging system already knows at the time when the reservation is made how many time units that will be consumed before the tariff time changes and how many units that will be consumed after. Similarly, the charging system can determine the units consumed before and the units consumed after the tariff switch in event that the user closes the session before the consumption of the complete reservation is used up. In this scenario there is no need for additional traffic between client and charging system in case of that absolute tariff time changes for continuous time based service.

In the case of time-based services where the quota is not continuously consumed at a regular rate, volume based services and event based services, the amount of resources used before respectively after a tariff change could not be predicted.

However, customers demand charging possibilities involving combined time based and for example volume based charging. In a case of an absolute time switch the first tariff use a different volume rate than the second tariff, it is necessary to know if the transferred data was before or after the time that initiated the tariff switch.

It is necessary to have a status report returned to the charging control and to do a consolidation/deduction on used amount as well as to prepare a new reservation for the new tariff at exactly the time of the switch. This means that if the tariff is set to change at an absolute time, all subscribers—that have sessions rating and have their session active or have PDP (Packet Data Protocol) context rating and have their PDP context active—need to report to the charging control for consolidation and new reservation. These status reports and actions performed in response to these reports will lead to an overloaded network and overloaded nodes. Alternatively, the network capacity must be overdimensioned.

It has been proposed for Diameter Credit Control application to force the DCC (Diameter Credit Control application) client, the CAMEL/CAP and the gprsSSF (gprs Service Switching Function), respectively to remember how much resources that were used before and after a switch. The charging system sends down the absolute time for the switch together with the units that is allowed to be consumed (DCC: time, uplink volume downlink volume and total volume, events and CAP: time, volume) and the DCC client/gprsSSF returns the amount before separated from the amount after. This report is sent back when the session is ended and/or the granted amount is used. Additionally, DCC has got a validity time connected to the granted units, which is sent to the client, the expiry of which also triggers a report. These solutions do however put requirements on a very complex implementation of the DCC client/gprsSSF. One complexity example is that the DCC client/gprsSSF needs a very accurate and synchronized clock something that is never a problem for the telecom equipment such as the gprsSSF but is a problem for DCC clients.

### SUMMARY OF THE INVENTION

Therefore, it is an object of the present invention to provide a method for combining charging of time and charging of unpredictable usage of services which usage is not continually consumed at a regular rate.

This object is achieved by a method of switching tariffs for combined charging of a service which is not continually consumed at a regular rate in an electronic communications network. The method is characterised by detecting an absolute time switch condition for switching a current time tariff and a current service usage tariff for said service, delaying the switching of the current service usage tariff until the end of the current time tariff, and switching said current service usage tariff to another service usage tariff.

The object is further achieved by a charging control device for working the method.

According to one aspect of the invention service usage tariff is a volume tariff and the volume tariff switch is delayed at absolute time switching.

Another aspect of the invention is that the always delay volume tariff switch is always delayed.

It should be emphasized that the term “comprises/comprising” when used in this specification is taken to specify the presence of stated features, integers, steps or components but does not preclude the presence or addition of one or more other features, integers, steps, components or groups thereof.

An advantage with the present invention is that signaling in a communications network due to tariff switches is reduced for combined time based charging and charging of services which execution that could not be predicted, e.g volume, non-continues time e.g. streamed audio that allows pausing, events such as SMS/MMS/games etc. Since all sessions are started almost randomly by the users, the method distributes the delayed switches randomly over time.

### BRIEF DESCRIPTION OF THE DRAWINGS

In order to explain the invention in more detail and the advantages and features of the invention, a preferred embodiment will be described in detail below, reference being made to the accompanying drawings, in which

FIG. 1 is a schematic view of an embodiment of a communications network including a charging control device according to the invention,

FIG. 2 is a schematic view of a part of the communications network of FIG. 1 in further detail,

FIG. 3A illustrates a part of a rating tree according to the invention,

FIG. 3B illustrates another part of the rating tree in FIG. 3A,

FIG. 4A is a timing diagram illustrating the lengths in which the tariffs in a first tariff set are to be used,

FIG. 4B is a timing diagram illustrating the length of the charging intervals of the time tariffs in the first tariff set,

FIG. 4C is a timing diagram illustrating the lengths in which the tariffs in a second tariff set are to be used,

FIG. 4D is a timing diagram illustrating the length of the charging intervals of the time tariffs in the second tariff set,

FIG. 4E is a timing diagram illustrating the steps of a method according to a first embodiment of the invention,

FIG. 4F is a timing diagram illustrating the steps of a method according to a second embodiment of the invention,

FIG. 5 is a flowchart of the first embodiment of the method according to the invention, and

FIG. 6 is a timing diagram illustrating the steps of a method according to a third embodiment of the invention.

### DETAILED DESCRIPTION OF THE INVENTION

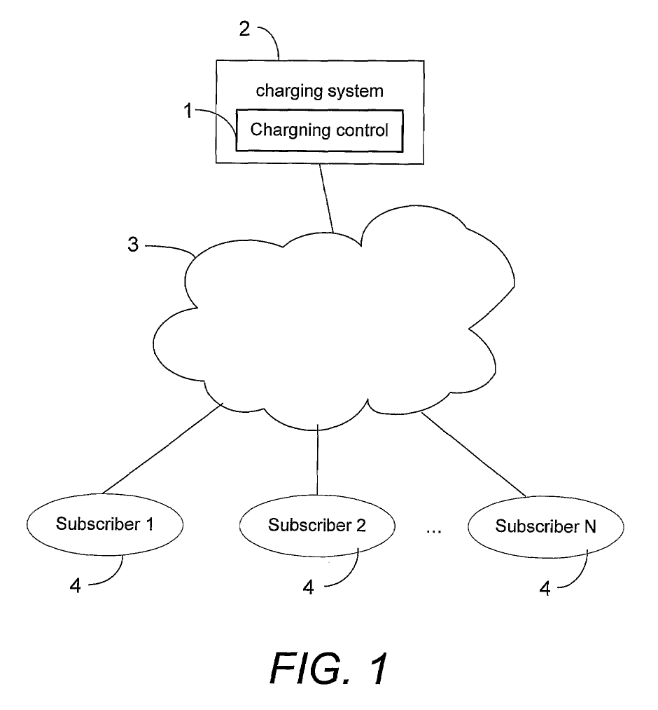

FIG. 1 shows an example of a communications system including a charging control device 1 or means for charging control according to the invention for performing tariff switching for charging of services in an electronic communications network, including time based charging and charging of services which execution that could not be predicted, i.e volume, non-continues time e.g. streamed audio that allows pausing, events such as SMS/MMS/games etc. The charging control device 1 forms part of a charging device or system 2 of a network 3. The network 3 is, but is not limited to PLMNs (public land mobile network), for example a cellular mobile telephone network, such as GSM, or CDMA, or UMTS, including a service providing network, such as an intelligent network (IN) facilitating service delivery for subscribers connected to the network. In this embodiment, the network also provides a pre-pay option and a method for determining rating data for pre-paid services for subscribers 4 in the communications network.

Some examples of different tele and data communications services, are regular phone calls, SMS, EMS, MMS, e-mail, WAP, GPRS, etc for users and providers, regional as well as world-wide.

The charging system 2 can be implemented as a digital electronic computer, including at least a working memory, a central processing unit (CPU). Moreover, the charging system 2 has a database, stored in a computer memory, containing service data needed for the service, including for example tariff data, subscriber data, group data etc. for determination of rating data. The charging system handles the rating, wherein a charging and rating function collects or accesses charging input parameters or data, which can be service data, subscriber related data, session data, call data, system data etc, received from an external service element of a service requested by a subscriber.

The charging system 2 performs rating of the requested service in response to at least one rating request or system call to the rating tree of the charging system.

A service element that can request services is for example an SSF via CAP or INAP, HLR via MAP, HSS (Home Subscriber Subsystem) and web servers/application servers via Diameter, SIP, open API via IP, i.e. OSA/Parlay, XML web-services via SOAP or any other server with an application requiring charging support, such as an e-commerce site movie/music server for streaming, a news site, WAP server or an SMSC/MMS-C, or another RAT (Radio Access Type) application. In those cases the charging input parameters can include for example an article identifier, number of events, kind of event, service, local time, destination number, originating or terminating location, distance, QoS, number of time slots, or utilised capacity etc.

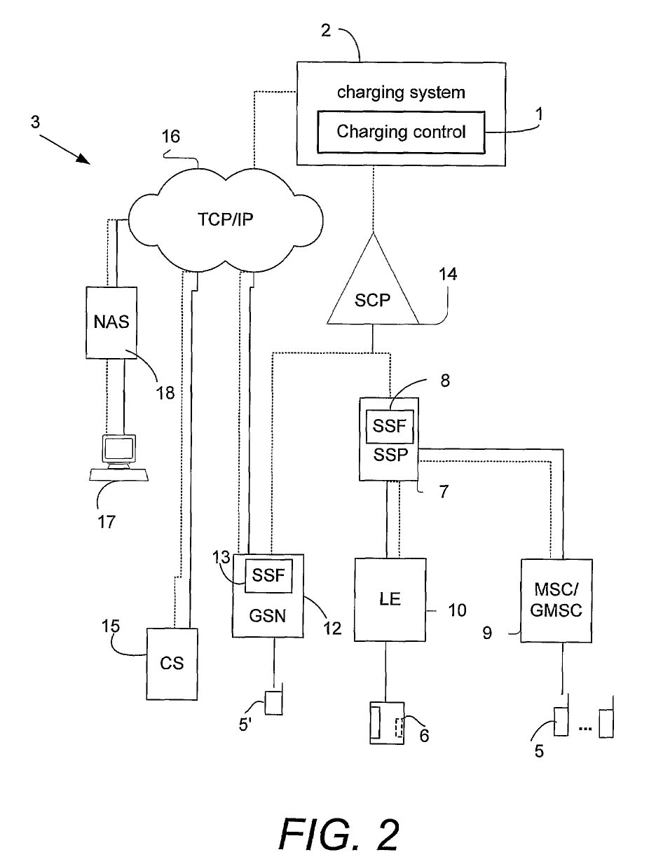

A user or subscriber 4 may access the charging control device 1 providing a charging and rating function CRF of the charging system 2 via a number of access methods which are further described with reference to FIG. 2. If the charging system is accessed via a user terminal such as a portable radio communication equipment 5 or a fixed telephone 6, the invocation is performed by a service switching point (SSP) 7 and its service switching function (SSF) 8 via an intermediate MSC/GMSC 9 for the portable radio communication equipment 5 and a local exchange (LE) 10 via a service control point SCP 11 for the fixed telephone 6. This is only an example embodiment and another interface may be used to connecting the MSC/GMSC9 directly with the charging control device 1.

The term portable radio communication equipment, which herein after is referred to as a mobile phone, includes all equipment such as pagers, communicators, i.e. electronic organizers, smartphones or the like.

If the charging control device 1 is invoked by a subscriber 4 due to usage via a mobile phone 5′ with GPRS capabilities, a GSN (GPRS support node) 12 will directly invoke the charging system 2 by means of its co-located service switching function (SSF) 13 via an SCP 14. If invoked due to usage of a service at a content server (CS) 15 connected to the Internet 16 accessed from a data terminal 17 through a network access server (NAS) 18, the content server (CS) 15 can directly access the charging system 2 via a TCP/IP network, such as the Internet 16. Access to an application server via a mobile phone will operate in the same way as when accessing from the data terminal 17, wherein the GSN 12 is operating as the NAS 18.

The charging control device 1 of FIG. 2 contains a database with service data needed for the service, including for example tariff data, subscriber data, group data etc. In this embodiment, rating and charging analysis is handled in the charging system 2, its charging control device 1, and SCP 14.

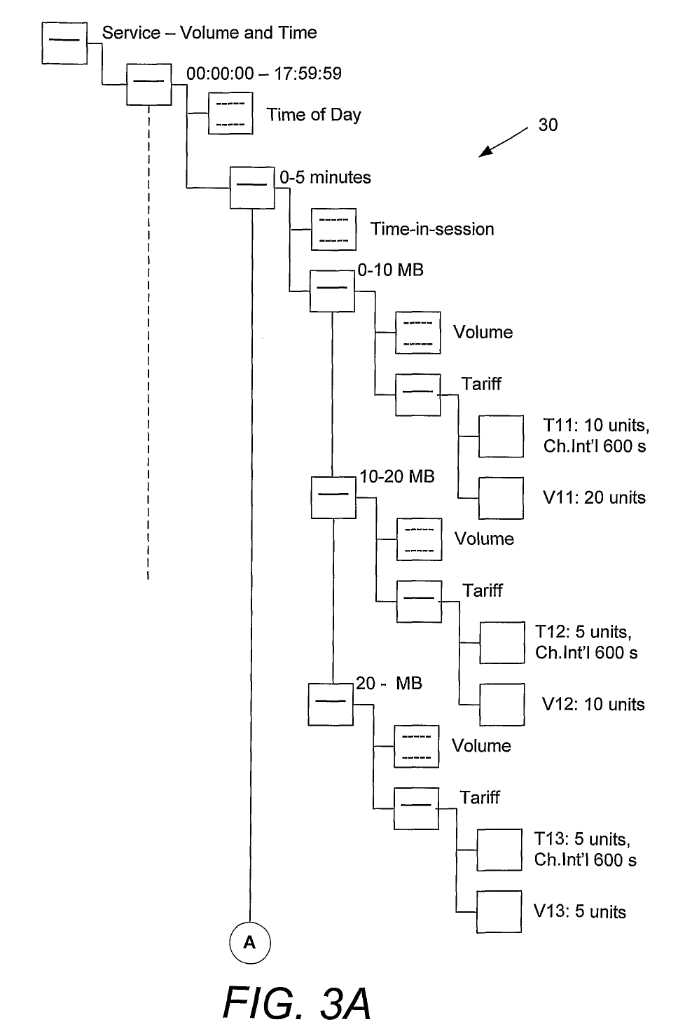

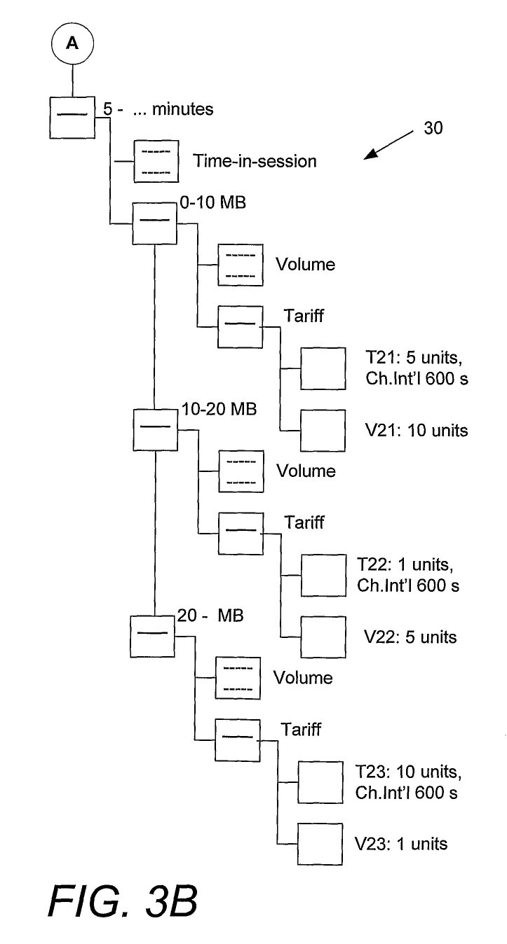

FIGS. 3A and 3B illustrates a part of a first embodiment of a tariff tree 30 of the rating device 1 according to the present invention. This example uses “exact” (i.e in the meaning of number of bytes, KBs etc.) calculation of volume, i.e referring to the volume, while the time is still on charging intervals. Charging intervals are however needed and used in an alterative embodiment where immediate tariff switching is used, in order to transfer the executed parts of the charging interval between the tariffs.

The rating tree of FIG. 3 comprises a condition for a “Service” with combined “Volume and Time” conditions for charging. The method and device is described in conjunction with, but the invention is not limited to, an example with a first tariff set applied during the absolute “Time of Day” 00:00:00-17:59:59. Hence, a second tariff set is applied from the absolute time 18:00:00.

During a “Time-in-session” from 0-5 minutes as shown in FIG. 3A, a first combined time and volume tariff is applied between 0-10 MB, a second combined time and volume tariff is applied between 10-20 MB, and a third combined time and volume tariff is applied from 20- . . . MB. The first combined time and volume tariff comprises a time tariff T11 for charging 10 units with a charging interval of 600s and a volume tariff V11 for charging 20 units. The second combined time and volume tariff comprises a time tariff T12 for charging 5 units with a charging interval of 600s and a volume tariff V12 for charging 10 units. The third combined time and volume tariff comprises a time tariff T13 for charging 5 units with a charging interval of 600s and a volume tariff V13 for charging 5 units.

With reference to FIG. 3B a “Time-in-session” from 5 minutes and so on implies a first combined time and volume tariff applied between 0-10 MB, a second combined time and volume tariff applied between 10-20 MB, and a third combined time and volume tariff applied from 20- . . . MB. The first combined time and volume tariff comprises a time tariff T21 for charging 5 units with a charging interval of 600s and a volume tariff V21 for charging 10 units. The second combined time and volume tariff comprises a time tariff T22 for charging 1 unit with a charging interval of 600s and a volume tariff V22 for charging 5 units. The third combined time and volume tariff comprises a time tariff T23 for charging 10 units with a charging interval of 600s and a volume tariff V23 for charging 1 unit.

As mentioned above, a second tariff set is applied from the absolute time 18:00:00 -.

A communication system involving a huge number of subscribers accessing a grate number of similar and/or different services requiring a lot of system resources signaling in connection with rating.

The method and device according to the present invention avoids network and node overload due to increased signaling and information flow in a system—using combined charging of services consuming unpredictable units such as volume—at an absolute time switch. According to the invention, time switching is applied as the foundation when there is tariff change due to an absolute time switch. Hence, the time switches will always use the delayed tariff switch in order to spread the different users over the time closely after the absolute time switch. In this switch case the volume tariff switch is delayed until the time tariff changes.

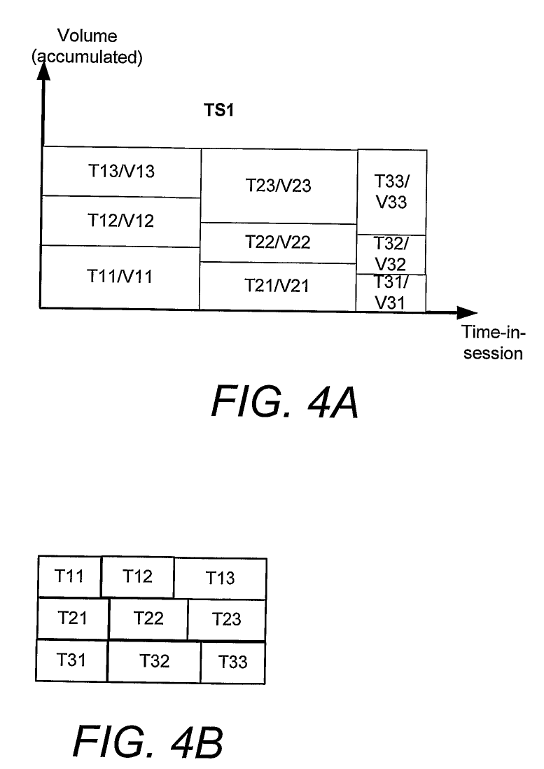

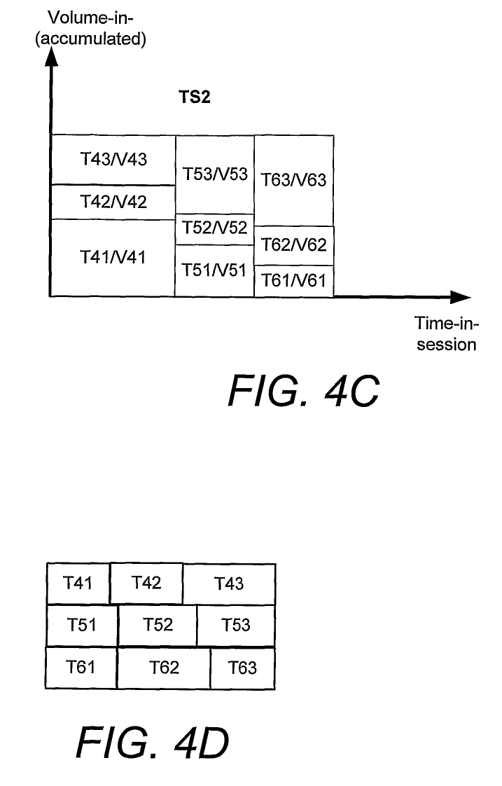

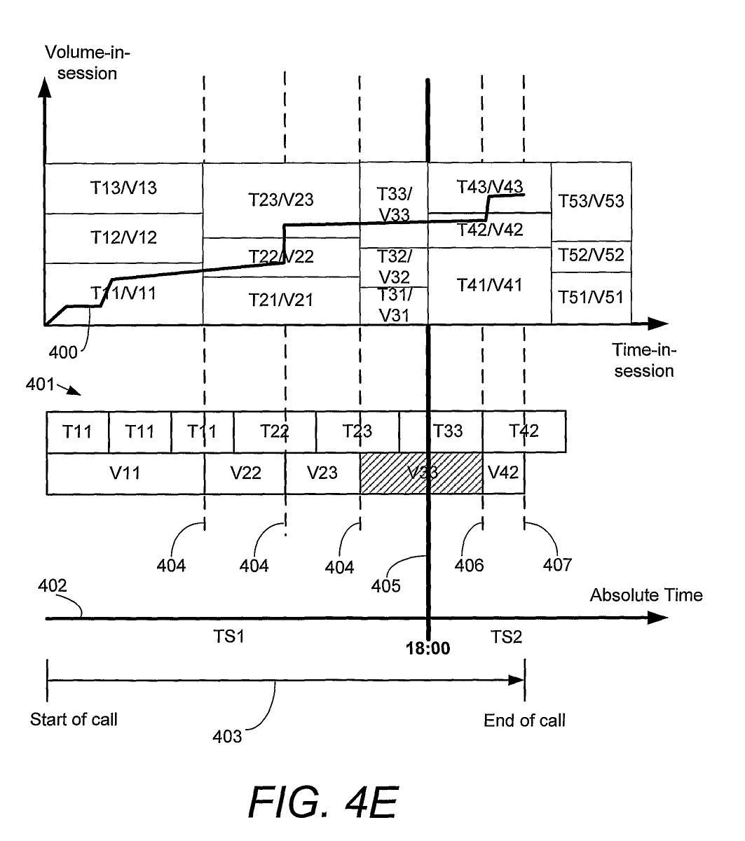

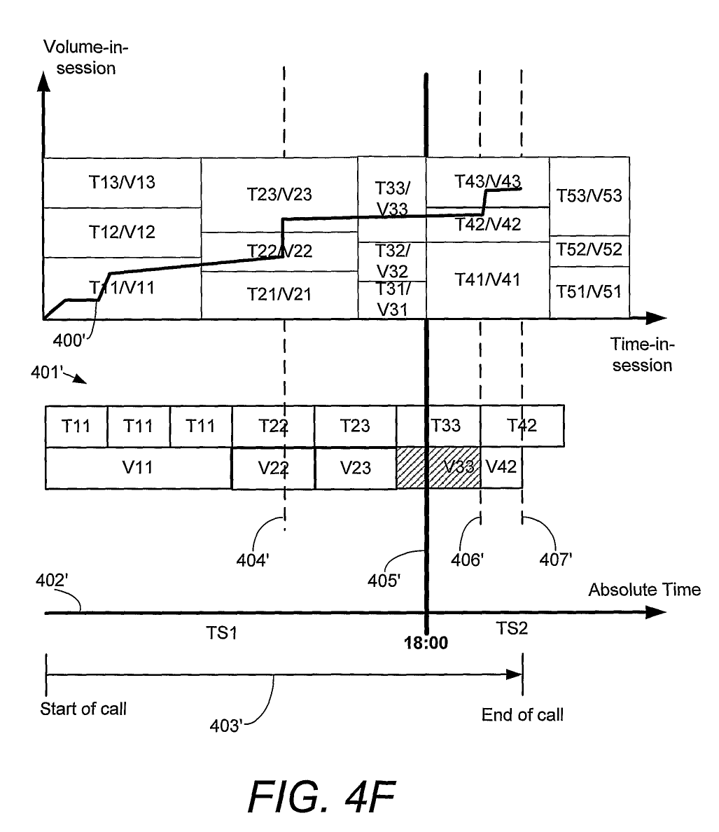

FIG. 4A is a timing diagram illustrating the conditions in which the tariffs in a first tariff set are to be used, with time on the horizontal axis and volume on the vertical axis. The different time tariffs: T11-T13, T21-T23, and T31-T33 and volume tariffs: V11-V13, V21-V23, and v31-V33 are only examples of time and volume tariffs, respectively, and are not intended to limit the scope of the invention.

FIG. 4B is a timing diagram illustrating the length of the charging intervals of the time tariffs in the first tariff set. The length of the charging intervals are represented by the horizontal length.

FIG. 4C is a timing diagram illustrating the conditions in which the tariffs in a second tariff set are to be used, with time on the horizontal axis and volume on the vertical axis. The different time tariffs: T41-T43, T51-T53, and T61-T63 and volume tariffs: V41-V43, V51-V53, and v61-V63 are only examples of time and volume tariffs, respectively, and are not intended to limit the scope of the invention.

FIG. 4D is a timing diagram illustrating the length of the charging intervals of the time tariffs in the second tariff set. The length of the charging intervals are represented by the horizontal length.

FIG. 4E is a timing diagram illustrating the steps of a method according to a first embodiment of the invention. The user activity, i.e the service usage, is illustrated by a bold line 400. The vertically increase of the bold line 400 corresponds to used volume and the horizontally increase corresponds to the spent time. The tariff plan according to FIGS. 4A and 4C is in the background of the bold line 400. The tariff plan illustrates how the tariffs should change if the intervals=0 sec. The boxes 401 below that shows which tariffs were really used, due to the delay in tariff switches. The absolute time is illustrated by an arrow 402 and the session duration is illustrated by an arrow 403. The first tariff set TS1 (as shown in FIG. 4A) is applied before the absolute time switch at 18:00 and the second tariff set TS2 (as shown in FIG. 4C) is to be applied after the absolute time switch. Vertical broken lines 404 in FIG. 4A illustrates immediate volume changes within a tariff set. The time tariffs are delayed, i.e full charging intervals are used, within the tariff set.

An extra bold vertical line 405 illustrates an absolute time switch at 18:00. According to this embodiment of the method of the present invention, “exact” volume calculation or volume calculation without intervals is used. The current volume tariff V33 is not immediately changed due to the absolute time tariff switch, but it is delayed to the next time switch from T33 to T42 at a broken line 406 to indicate this special case from the relative switches. End of session is illustrated by a broken line 407. However, regarding the time tariff T42 a full charging interval is used.

Before the charging control device 2 performs the core steps of the invention the system has to go through some steps to activate the charging. The charging and rating function is initiated by a request from a user via its mobile phone 5,5′, fixed telephone 6, or data terminal 17 and is triggered by the network equipment (SSF, NAS, CS, AS etc) and proceeds with traversing the tariff structure in FIG. 4, while calculating the cost of a purchase or a chargeable event. Examples of a requested service are browsing using WAP or ordinary web surfing, get access to music/video by streaming or download. Other examples include MMS that could depend on: time, i.e how long did the user use its connection; volume, i.e the total amount of data or one MMS; and event, i.e the number of recipients. Thus, the service is requested by a user of the mobile phone 5. A signal triggering the charging and rating function is transmitted to the charging control device 1 via the MSC 9 to the SSP 7 to the SCP 14 and is received by the charging control device 1 of the charging system 2. According to this embodiment of the method the rating or charging control device 1 receives the signal and necessary parameters for a requested charging. The charging system is configured to access its tariff or rating tree, in response to the requested service. The rating is performed by entering the rating tree at the condition for the requested service, i.e at “Service—Volume and Time.

The charging and rating function CRF of the charging control device 1 collects or accesses charging input parameters or data such as: service data, subscriber related data, session data, call data, system data etc, received from the external service element of a service requested by a subscriber.

The subscriber has an account registered for one or more services at a service provider. A service element that can request services is for example an SSF (service switching function) via CAP (Camel application part) or INAP (Intelligent network application part), HLR (Home location register) via MAP (mobile application part), HSS (Home Subscriber Subsystem), web servers/application servers via Diameter, SIP (session initiation protocol), open API via IP, i.e OSA/Parlay, XML web-services via SOAP or any other server with an application requiring charging support, such as an e-commerce site movie/music server for streaming, a news site, WAP server or an SMSC/MMS-C. The charging input parameters are an article, number of events, kind of event, service, local time, destination number, originating or terminating location, distance, QoS, number of time slots, utilised capacity, destination and origin in terms of actors e.g. subscribers etc.

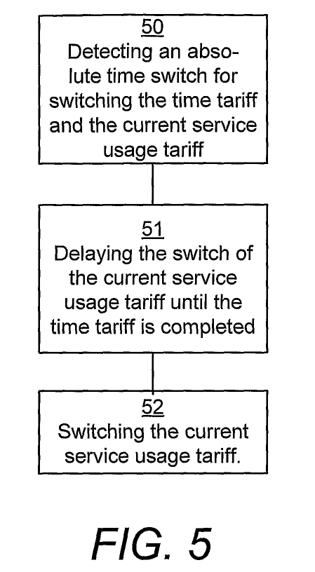

FIG. 5 is a flowchart of the first embodiment of the method according to the invention. In this particular example the method operates on a rating tree similar to that of FIG. 3. The charging control device 2 detects or predicts an absolute time switch for switching the time tariff and the volume tariff from a first tariff set to a second tariff set in step 50. The charging control device 2 makes sure that the switch of the volume tariff is delayed until the time tariff is completed before switching to time and volume tariffs of the next tariff set in step 52. Hence, the reservation is a prediction and the deduct is more working on facts, thus detects. The method of deciding the tariffs are to always predict the most expensive case when deciding which tariff to predict. This is performed in order to make sure that no more resources than for which it has been reserved money will be spent.

FIG. 4F is a timing diagram illustrating the steps of a method according to a second embodiment of the invention. The user activity, i.e the service usage, is illustrated by a bold line 400′. The vertically increase of the bold line 400′ corresponds to used volume and the horizontally increase corresponds to the spent time. The tariff plan according to FIGS. 4A and 4C is in the background of the bold line 400′. The tariff plan illustrates how the tariffs should change if the intervals=0 sec. The boxes 401′ below that show which tariffs were really used, due to the delay in tariff switches. The absolute time is illustrated by an arrow 402′and the call duration is illustrated by an arrow 403′. The first tariff set TS1 (as shown in FIG. 4A) is applied before the absolute time switch at 18:00 and the second tariff set TS2 (as shown in FIG. 4B) is to be applied after the absolute time switch. A vertically broken line 404′ in FIG. 4B illustrates an immediate volume change within a tariff set. The time tariffs use charging intervals. The volume tariffs are delayed to times when the time tariffs are changed. Thereby, the reporting of volume is distributed over time in the same way as the time switches.

An extra bold vertical line 405′ illustrates an absolute time switch at 18:00. Also, according to this second embodiment of the method of the present invention, “exact” volume calculation is used. However, volume switches are not only delayed at absolute time switches but also volume switches within the same tariff set are delayed to the next time switch. See for example the switch at 404′, wherein the volume tariff V22 is delayed to the end of T22 within the first tariff set TS1. The absolute time switch causes the same delay of the volume switch from V33 to V42 as in the first embodiment, i.e it is delayed to the next time switch from T33 to T42 illustrated by a broken line 406′. End of session is illustrated by a broken line 407′.

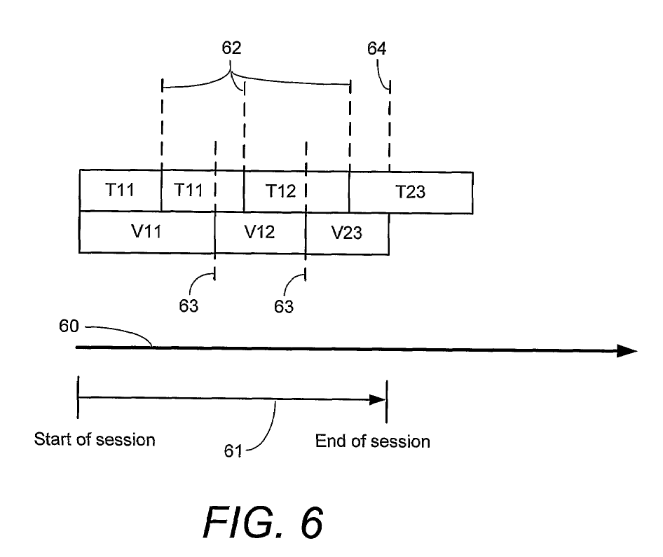

FIG. 6 is a timing diagram illustrating the steps of a method according to a third embodiment of the invention. Charging intervals are used for volume and the method does not use the “exact” method as described in the first and second embodiments. At least a time tariff switch condition for switching a current time tariff and at least a volume tariff switch condition for switching a current volume tariff from a combined set of a time tariff and a volume tariff are individually detected. The switching of the at least one time tariff is delayed until the end of said current time tariff, i.e the charging interval for time, and the switching of the at least one volume tariff is delayed until the end of said current volume tariff, i.e the charging interval for volume, individually. The current time tariff is switched to another time tariff and the current volume tariff is switched to another volume tariff, individually. The time-in-session is illustrated by an arrow 60 and the session duration is illustrated by an arrow 61. Each of the broken lines 62 illustrates delayed changes of the time tariffs and vertical broken lines 63 in illustrates delayed volume changes within a tariff set. The vertical broken line 64 illustrates the end of session.

The method of the present invention is preferably implemented in computer software executable preferably by a data processing apparatus or system forming part of the overall communication system. In this embodiment of the invention, the computer processor of the charging control device 1 in the network is configured to work the steps of the method.

Hence, it should be apparent that the present invention provides an improved method and device for use in an electronic communication network, comprising a rating and charging mechanism that provides for determining rating data for services in a communications network to a user in a communications system that fully satisfies the aims and advantages set forth above.

Although the invention has been described in conjunction with specific embodiments thereof this invention is susceptible of embodiments in different forms, with the understanding that the present disclosure is to be considered as an exemplification of the principles of the invention and is not intended to limit the invention to the specific embodiments illustrated. Particularly rating trees or part of rating trees of FIG. 3A and FIG. 3B are only examples and are not intended to limit the scope of the invention. The method an device according to the invention are configurable to operate on a variation of rating trees or part of rating trees. However, the tree is only a graphical representation of the rating and tariff logic. The presentation could be illustrated in other ways, e.g. by chopping up time in segments in the tree and work on them individually.

Although, the invention supports absolute time switches for services that are not consuming resources at a regular interval in general, should be noted that these services could be based also on events and time, i.e time that is not continuous). Hence, the present invention provides a method that reduces signaling in a communications network due to tariff switches for combined time based and volume based charging and other services which execution that could not be predicted (volume, non-continues time (e.g. steamed audio that allows pausing, events such as SMS/MMS/games etc.)

The method of the present invention can also be implemented in computer software executable preferably by a distributed data processing system forming part of the overall communication system.

1. A method of switching tariffs for charging of a service which is not continually consumed at a regular rate in an electronic communications network, comprising detecting an absolute time switch condition for switching a current time tariff and a current service usage tariff for said service, delaying the switching of the current service usage tariff until the end of the current time tariff, and switching said current service usage tariff to another service usage tariff.

2. A method according to claim 1, further comprising the step of detecting a service usage tariff switch condition before or after the detection of said absolute time switch condition, delaying the switching of the current service usage tariff until the end of the current time tariff, and switching said current service usage tariff to another service usage tariff.

3. A method according to claim 1, wherein said service usage tariff to be switched is volume based.

4. A method according to claim 1, wherein said service usage tariff to be switched is based on non-continues time e.g. streamed audio that allows pausing, and events such as SMS/MMS/games.

5. A method of switching tariffs for charging of services in an electronic communications network, including time based and volume based charging, comprising: individually detecting at least a time tariff switch condition for switching a current time tariff and at least a volume tariff switch condition for switching a current volume tariff from a combined set of a time tariff and a volume tariff, individually delaying the switching of said at least one time tariff until the end of said current time tariff and the switching of said at least one volume tariff until the end of said current volume tariff, and individually switching said current time tariff to another time tariff and switching said current volume tariff to another volume tariff.

6. A computer program comprising program instructions for causing a computer to perform the method according to claim 1.

7. A computer program on a carrier and comprising computer executable instructions for causing a computer to perform the method according to claim 1.

8. A computer program according to claim 7, wherein said carrier is a record medium, computer memory, read-only memory or an electrical carrier signal.

9. A device for performing tariff switching for charging of services in an electronic communications network, including time based and volume based charging, comprising a charging control device including a computer apparatus adapted to perform the method of claim 1.
